(19) United States
(12) Patent Application Publication
(10) Pub. No.: US 2026/0186657 A1
(43) Pub. Date: Jul. 2, 2026

(54) STORAGE CONTROLLER AND STORAGE DEVICE INCLUDING THE SAME

(71) Applicant: Samsung Electronics Co., Ltd., Suwon-si (KR)

(72) Inventors: Damin Son, Suwon-si (KR); Wooseong Cheong, Suwon-si (KR)

(21) Appl. No.: 19/236,634

(22) Filed: Jun. 12, 2025

(30) Foreign Application Priority Data
Dec. 30, 2024 (KR) 10-2024-0199963

(51) Int. Cl. G06F 3/06

(52) U.S. Cl. CPC G06F 3/0611; G06F 3/0656; G06F 3/0659; G06F 3/0679

(57) ABSTRACT

An example of a storage device includes a nonvolatile memory device including a plurality of planes and a plurality of page buffers respectively connected to the planes, and a storage controller configured to provide a read command for reading data stored in the planes to the nonvolatile memory device, provide a first select chip pause command for instructing data output of a first plane of the planes to the nonvolatile memory device, and provide a second select chip pause command for pausing data output of the first plane and instructing data output of a second plane of the planes to the nonvolatile memory device.

### CROSS-REFERENCE TO RELATED APPLICATION

This application claims priority under 35 U.S.C. § 119 to and the benefit of Korean Patent Application No. 10-2024-0199963 filed with the Korean Intellectual Property Office on Dec. 30, 2024, the entire contents of which are incorporated herein by reference.

### BACKGROUND

The storage device may include a nonvolatile memory device that stores data and a storage controller that controls the nonvolatile memory device. The storage controller may communicate with a nonvolatile memory device according to a separated command address (SCA) protocol. In the SCA protocol, a storage controller may provide a command to the nonvolatile memory device via a command/address line while receiving data from the nonvolatile memory device via a data line.

### SUMMARY

The present disclosure relates to a storage device including a storage controller and a nonvolatile memory device.

Embodiments attempt to provide a storage device including a storage controller and a nonvolatile memory device for reducing a time required for data communication for data output of the nonvolatile memory device.

An embodiment of the present disclosure provides a storage device including a nonvolatile memory device including a plurality of planes and a plurality of page buffers respectively connected to the planes, and a storage controller configured to provide a read command for reading data stored in the planes to the nonvolatile memory device, provide a first select chip pause command for instructing data output of a first plane among the planes to the nonvolatile memory device, and provide a second select chip pause command for pausing data output of the first plane and instructing data output of a second plane among the planes to the nonvolatile memory device.

An embodiment of the present disclosure provides a memory device including a memory cell array including a plurality of planes, a plurality of page buffers connected to the respective planes, and a control logic circuit configured to sense data stored in the planes in the page buffers in response to a read command received from outside, and control the page buffers to output first data stored in a first page buffer connected to a first plane among the planes to the outside, and in response to a first select chip pause command received from the outside, to pause output of the first data and output second data stored in a second page buffer connected to a second plane among the planes to the outside.

An embodiment of the present disclosure provides an operating method for a storage controller, including outputting a read command for reading data stored in a plurality of planes included in a nonvolatile memory device, outputting a first select chip pause command that instructs data output of a first plane among the planes, and pausing data output of the first plane and outputting a second select chip pause command that instructs data output of a second plane among the planes.

### BRIEF DESCRIPTION OF THE DRAWINGS

FIG. 1 illustrates a view for describing an electronic system including a storage device according to an embodiment.

FIG. 2 illustrates a view for describing pins of a storage controller and a nonvolatile memory device according to an embodiment.

FIG. 3 illustrates a view for describing a connection relationship between a storage controller and a plurality of nonvolatile memory devices according to an embodiment.

FIG. 4 illustrates a view for describing a separated command address (SCA) packet transmitted via a command/address line according to an embodiment.

FIG. 5 illustrate a view for describing a header and body included in an SCA packet according to an embodiment.

FIG. 6 illustrates a view for describing a nonvolatile memory device according to an embodiment.

FIG. 7 and FIG. 8 each illustrate a data output operation using a select chip enable command and a select chip pause command according to an embodiment.

FIG. 9 illustrate a view for describing a select chip pause/enable command according to an embodiment.

FIG. 10 and FIG. 11 each illustrate a view for describing a data output operation using a select chip pause/enable command according to an embodiment.

FIG. 12 illustrates a view for describing a storage controller that generates a first command set or a second command set according to an embodiment.

FIG. 13 illustrates a data output operation using a select chip enable command and a select chip pause/enable command according to an embodiment.

FIG. 14 illustrate a view for describing a select chip enable command according to an embodiment.

FIG. 15 illustrates a data output operation using a select chip pause/enable command and a select chip pause/terminate command according to an embodiment.

FIG. 16 illustrate a view for describing a select chip pause/terminate command according to an embodiment.

FIG. 17 illustrates a flowchart for describing a storage controller that generates a first command set or a second command set according to an embodiment.

FIG. 18 illustrates a flowchart showing an operating method for a storage device according to an embodiment.

FIG. 19 illustrates a view for describing a storage system according to an embodiment.

FIG. 20 illustrates a view for describing a universal flash storage (UFS) system according to an embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

To clearly describe the present disclosure, parts that are irrelevant to the description are omitted, and like numerals refer to like or similar components throughout the specification.

In addition, unless explicitly described to the contrary, the word “comprise” and variations such as “comprises” or “comprising” will be understood to imply the inclusion of stated elements but not the exclusion of any other elements.

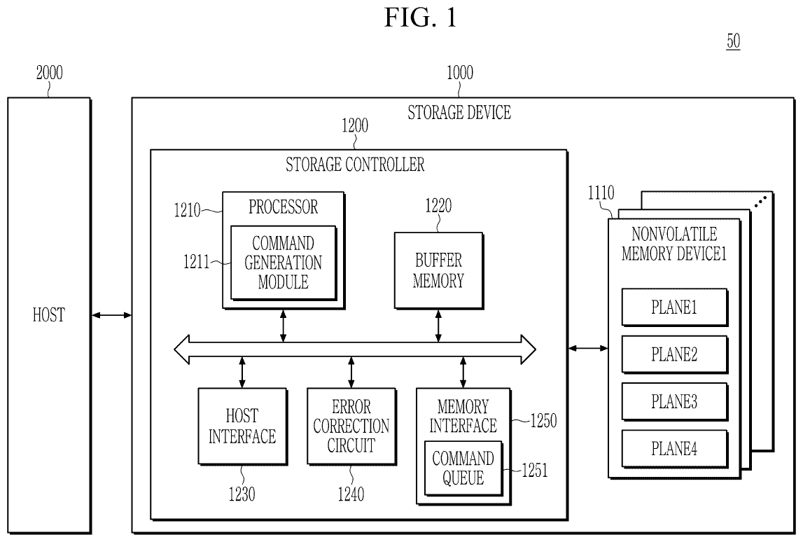

FIG. 1 illustrates a view for describing an electronic system including a storage device according to an embodiment.

Referring to FIG. 1, the electronic system 50 may include a storage device 1000 and a host 2000.

The storage device 1000 may be a device that stores data under control of the host 2000. In an embodiment, the storage device 1000 may be manufactured in a form of a solid state drive (SSD) or a universal flash storage (UFS).

In an embodiment, the storage device 1000 may include a plurality of nonvolatile memory devices and a storage controller 1200. In some embodiments, the storage controller 1200 may be located outside the memory device and thus may also be referred to as a first device in the present disclosure.

In an embodiment, a first nonvolatile memory device 1110 among the nonvolatile memory devices may store data. The first nonvolatile memory device 1110 may operate in response to the control of the storage controller 1200. In an embodiment, the first nonvolatile memory device 1110 may be a NAND flash memory. In an embodiment, the first nonvolatile memory device 1110 may include first to fourth planes PLANE1 to PLANE4. In an embodiment, the first to fourth planes PLANE1 to PLANE4 may perform program operations or read operations in parallel. In an embodiment, the first to fourth planes PLANE1 PLANE4 may each include a plurality of memory blocks BLK1 to BLKz. Each of the memory blocks BLK1 to BLKz may include a plurality of pages. One page may be a unit that performs a program operation or a read operation. In an embodiment, the pages may each include a plurality of memory cells that store data.

In an embodiment, the nonvolatile memory device 1110 may receive a command and an address from the storage controller 1200, and may perform an operation indicated by the command for a region selected by the address. The first nonvolatile memory device 1110 may perform a program operation (write operation) for storing data in a region selected by an address, a read operation for reading data, or an erase operation for deleting data. In an embodiment, remaining nonvolatile memory devices among the nonvolatile memory devices may operate identically to the first nonvolatile memory device 1110.

The storage controller 1200 may control a general operation of the storage device 1000.

In an embodiment, the storage controller 1200 may execute firmware when power is applied to the storage device 1000. The firmware may include a host interface layer that controls communication with the host 2000, a flash translation layer that controls communication between the host 2000 and the first nonvolatile memory devices 1110, and a memory interface layer that controls communication with the first nonvolatile memory devices 1110. In an embodiment, the flash translation layer may translate a logical address of the host 2000 into a physical address of the first nonvolatile memory devices 1110.

In an embodiment, the storage controller 1200 may control the first nonvolatile memory devices 1110 to perform a write operation, a read operation, or an erase operation, etc., according to a command of the host 2000. The storage controller 1200 may provide a write command, an address, and data to the first nonvolatile memory device 1110 during the write operation. The storage controller 1200 may provide a read command and an address to the first non-volatile memory device 1110 during the read operation. The storage controller 1200 may provide an erase command and an address to the first nonvolatile memory device 1110 during the erase operation.

In an embodiment, the storage controller 1200 may include a processor 1210, a buffer memory 1220, a host interface 1230, an error correction circuit 1240, and a memory interface 1250.

In an embodiment, the processor 1210 may control a general operation of the storage controller 1200. The processor 1210 may control a program operation according to a write request from the host 2000 and a read operation according to a read request from the host 2000.

In an embodiment, the processor 1210 may include a command generation module 1211. In an embodiment, the command generation module 1211 may generate commands to be provided to a plurality of non-volatile memory devices. In an embodiment, the command generation module 1211 may generate a read command and a data output command. In an embodiment, the read command may be a command to read data stored in multiple planes of a single nonvolatile memory device. In an embodiment, the data output command may be a command that determines which data to be output among data of the multiple planes.

In an embodiment, the command generation module 1211 may generate a select chip enable command, a select chip pause command, and a select chip terminate command according to the separated command address SCA protocol.

In an embodiment, the command generation module 1211 may generate a select chip pause/enable command that pauses data output of one plane and instructs data output of another plane. In an embodiment, the command generation module 1211 may generate a select chip pause/terminate command that pauses data output of one plane and terminate data output of one nonvolatile memory device including one plane.

In an embodiment, the buffer memory 1220 may be used as a cache memory or an operating memory of the storage controller 1200.

In an embodiment, the buffer memory 1220 may temporarily store data provided from the host 2000, or may temporarily store data read from a nonvolatile memory device 1110. In an embodiment, the buffer memory 1220 may be a dynamic random access memory (DRAM) or a static random access memory (SRAM). In an embodiment, the buffer memory 1220 may be positioned within the storage controller 1200 or may be positioned outside the storage controller 1200.

In an embodiment, the host interface 1230 may communicate with the host 2000. The host interface 1230 may receive a request or data from the host 2000, or provide a response to a request or data to the host 2000.

In an embodiment, the error correction circuit 1240 may perform an encoding operation to generate parity data for data received from the host 2000. The encoded data may be provided to the first nonvolatile memory device 1110 via the memory interface 1250. The error correction circuit 1240 may perform an error correction operation on data read from the first nonvolatile memory device 1110. The error correction circuit 1240 may perform an error correction operation to correct error bits included in data read from the first nonvolatile memory device 1110. The error correction circuit 1350 may provide error-corrected data to the host 2000 through the host interface 1230.

In an embodiment, the memory interface 1250 may communicate with the first nonvolatile memory device 1110. The memory interface 1250 may provide a command or data to the first nonvolatile memory device 1110, or may receive data from the first nonvolatile memory device 1110.

In an embodiment, the memory interface 1250 may include a command queue 1251. In an embodiment, the command queue 1251 may store commands generated by the command generation module 1211. The command queue 1251 may provide commands to multiple nonvolatile memory devices.

In an embodiment, the host 2000 may communicate with the storage device 1000 using an interface such as non-volatile memory express (NVMe), universal flash storage (UFS), peripheral component interconnect express (PCIe), universal serial bus (USB), double data rate (DDR), low power DDR (LPDDR), serial advanced technology attachment (SATA), small computer system interface (SCSI), etc.

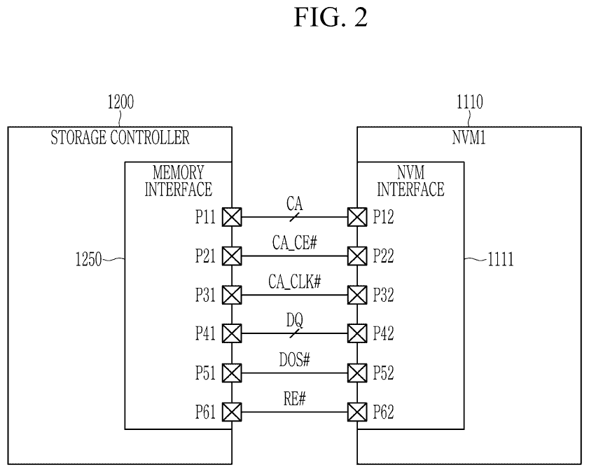

FIG. 2 illustrates a view for describing pins of a storage controller and a nonvolatile memory device according to an embodiment.

Referring to FIG. 2, the storage controller 1200 and the first nonvolatile memory device 1110 may transmit and receive signals through multiple lines connected to multiple pins.

In an embodiment, the storage controller 1200 may include a memory interface 1250. The memory interface 1250 may include an eleventh pin P11, a twenty-first pin P21, a thirty-first pin P31, a forty-first pin P41, a fifty-first pin P51, and a sixty-first pin P61.

In an embodiment, the first nonvolatile memory device 1110 may include an NVM interface 1111. In an embodiment, the NVM interface 1111 may include a twelfth pin P12, a twenty-second pin P22, a thirty-second pin P32, a forty-second pin P42, a fifty-second pin P52, and a sixty-second pin P62.

In an embodiment, a command/address line CA may be connected to the eleventh pin P11 and the twelfth pin P12. The storage controller 1200 may provide a command and an address to the first nonvolatile memory device 1110 via the command/address line CA.

In an embodiment, the command/address chip enable line CA_CE # may be connected to the 21^{st} pin P21 and the 22^{nd} pin P22. The storage controller 1200 may provide a chip enable signal to the first nonvolatile memory device 1110 via the command/address chip enable line CA_CE #. The chip enable signal may be a signal that selects a non-volatile memory device to which commands and addresses will be provided via the command/address line CA_CE #.

In an embodiment, the command/address clock line CA_CLK #may be connected to the 31^{st} pin P31 and the 32^{nd} pin P32. The storage controller 1200 may provide a command/address clock signal to the first nonvolatile memory device 1110 through the command/address clock line CA_CLK #. The command/address clock signal may be toggled when a command and an address are provided to the first nonvolatile memory device 1110 via the command/address line. In an embodiment, the first nonvolatile memory device 1110 may receive a command and an address from the storage controller 1200 in response to a rising edge and a falling edge of a command/address clock signal.

In an embodiment, a data line DQ may be connected to the 41^{st} pin P41 and the 42^{nd} pin P42. In an embodiment, the storage controller 1200 may provide data to the first nonvolatile memory device 1110 via the data line DQ. In an embodiment, the first nonvolatile memory device 1110 may provide data stored in the first nonvolatile memory device 1110 to the storage controller 1200 through the data line DQ.

In an embodiment, a data strobe line DQS # may be connected to the 51^{st} pin P51 and the 52^{nd} pin 52 P52. In an embodiment, the storage controller 1200 may provide a data strobe signal to the first nonvolatile memory device 1110 via the data strobe line DQS #. The data strobe signal may be toggled when data is provided from the storage controller 1200 to the first nonvolatile memory device 1110 via the data line DQ. The data strobe signal may be toggled when data is provided from the first nonvolatile memory device 1110 to the storage controller 1200 via the data line DQ. The storage controller 1200 or the first nonvolatile memory device 1110 may receive data in response to a rising edge and a falling edge of the data strobe signal.

In an embodiment, the read enable line RE # may be connected to the 61^{st} pin P61 and the 62^{nd} pin P62. In an embodiment, the storage controller 1200 may provide a read enable signal to the first nonvolatile memory device 1110 via the read enable line RE #. The read enable signal may be toggled when data is provided from the first nonvolatile memory device 1110 to the storage controller 1200 via the data line DQ.

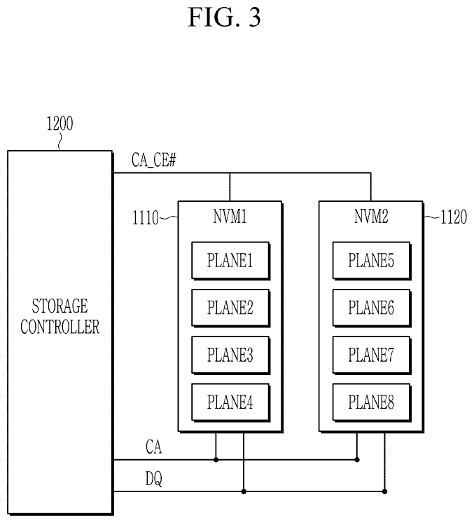

FIG. 3 illustrates a view for describing a connection relationship between a storage controller and a plurality of nonvolatile memory devices according to an embodiment.

Referring to FIG. 3, the first nonvolatile memory device 1110 may include first to fourth planes PLANE1 to PLANE4. In an embodiment, the second nonvolatile memory device 1120 may include fifth to eighth planes PLANE5 to PLANE8.

In an embodiment, the first nonvolatile memory device 1110 and the second nonvolatile memory device 1120 may be connected to the storage controller 1200 via the command/address chip enable line CA_CE #. The storage controller 1200 may output a chip enable signal for selecting a nonvolatile memory device to provide a command and an address among the first nonvolatile memory device 1110 and the second nonvolatile memory device 1120 via the command/address chip enable line CA_CE #.

In an embodiment, the first nonvolatile memory device 1110 and the second nonvolatile memory device 1120 may be commonly connected to the command/address line CA. The first nonvolatile memory device 1110 and the second nonvolatile memory device 1120 may receive commands and addresses from the storage controller 1200 via the command/address line CA.

In an embodiment, the first nonvolatile memory device 1110 and the second nonvolatile memory device 1120 may be commonly connected to the data line DQ. The first nonvolatile memory device 1110 and the second nonvolatile memory device 1120 may provide data to the storage controller 1200 via the data line DQ. The first nonvolatile memory device 1110 and the second nonvolatile memory device 1120 may receive data from the storage controller 1200 via the data line.

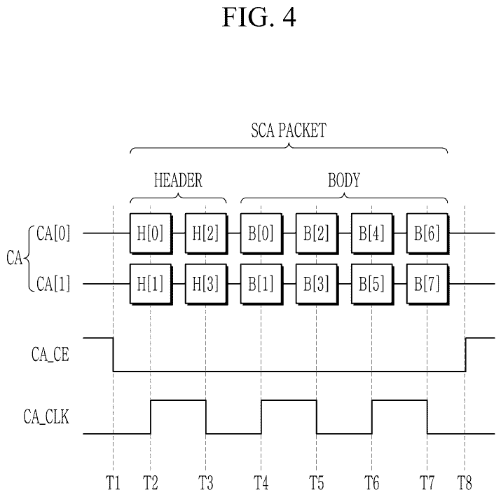

FIG. 4 illustrates a view for describing a separated command address (SCA) packet transmitted via a command/address line according to an embodiment.

Referring to FIG. 4, the storage controller 1200 and a plurality of nonvolatile memory devices may transmit and receive commands, addresses, or data according to a separated command address (SCA) protocol. In an embodiment, the SCA protocol may involve transmitting commands and addresses via command/address lines CA, and input/output of data to be stored in or read from multiple nonvolatile memory devices via data lines DQ.

In an embodiment, a command or an address transmitted via the command/address line CA may include an SCA packet. The SCA packet may include header data HEADER and body data BODY.

In an embodiment, the header data HEADER may be data indicating a type of SCA packet. In an embodiment, the header data HEADER may include data indicating that the type of SCA packet is a command or an address. In an embodiment, the header data HEADER may include a zeroth header H[0], a first header H[1], a second header H[2], and a third header H[3].

In an embodiment, the body data BODY may include additional information related to the header data HEADER. In an embodiment, the body data BODY may include a zeroth body B[0], a first body B[1], a second body B[2], a third body B[3], a fourth body B[4], a fifth body B[5], a sixth body B[6], and a seventh body B[7].

In an embodiment, the storage controller 1200 may provide SCA packets to multiple nonvolatile memory devices via a zeroth command/address line CA[0] and a first command/address line CA[1] when there are two command/address lines CA. While a CA packet is provided to the multiple nonvolatile memory devices, a level of the command/address chip enable signal CA_CE may transition from a high level to a low level.

In an embodiment, the command/address clock signal CA_CLK may be toggled while SCA packets are provided to the multiple nonvolatile memory devices. In an embodiment, the nonvolatile memory devices may receive the zeroth header H[0] and the first header H[1] in response to a rising edge of a command/address clock signal CA_CLK, and may receive the second header H[2] and the third header H[3] in response to a falling edge of the command/address clock signal CA_CLK. In an embodiment, the nonvolatile memory devices may receive zeroth to seventh bodies B[0] to B[7] transmitted from the storage controller 1200 in response to the rising edge and the falling edge of the command/address clock signal CA_CLK.

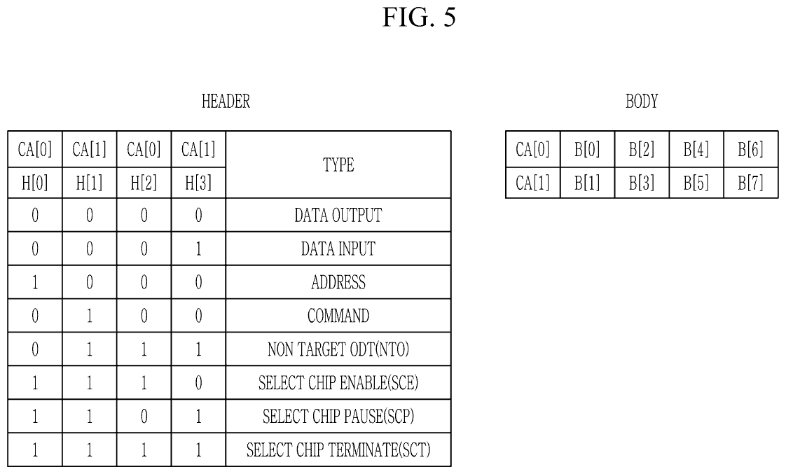

FIG. 5 illustrate a view for describing a header and body included in an SCA packet according to an embodiment.

Referring to FIG. 5, an SCA packet transmitted via the command/address line CA may include header data HEADER and body data BODY. The header data HEADER may include the 0^{th} to 3^{rd} headers H[0] to H[3]. The zeroth header (H[0]) and the second header (H[2]) may be transmitted to the multiple nonvolatile memory devices via a zeroth command/address line CA[0]. The first header H[1] and the third header H[3] may be transmitted to the nonvolatile memory devices via a first command/address line CA[1].

In an embodiment, an SCA packet including bit values of the 0^{th} to 3^{rd} headers H[0] to H[3] corresponding to “0000” may correspond to a data output packet (DATA OUTPUT). In an embodiment, the data output packet (DATA OUTPUT) may be a packet transmitted by the multiple nonvolatile memory devices to the storage controller 1200. The 0^{th} to 7^{th} bodies B[0] to B[7] of the data output packet (DATA OUTPUT) may include data that the multiple nonvolatile memory devices will provide to the storage controller 1200 via the command/address line CA.

In an embodiment, an SCA packet including bit values of the 0^{th} to 3^{rd} headers H[0] to H[3] corresponding to “0001” may correspond to a data input packet (DATA INPUT). In an embodiment, the data input packet (DATA INPUT) may be a packet that the storage controller 1200 transmits to the nonvolatile memory devices. The 0^{th} to 7^{th} bodies B[0] to B[7] of the data input packet (DATA INPUT) may include data to be provided by the storage controller 1200 to the nonvolatile memory devices via the command/address line CA.

In an embodiment, an SCA packet including bit values of the 0^{th} to 3^{rd} headers H[0] to H[3] corresponding to “1000” may correspond to an address packet (ADDRESS). The 0^{th} to 7^{th} bodies B[0] to B[7] of the address packet (ADDRESS) may include data representing memory block addresses or page addresses of the nonvolatile memory devices.

In an embodiment, an SCA packet including bit values of the 0^{th} to 3^{rd} headers H[0] to H[3] corresponding to “0100” may correspond to a command packet (COMMAND). The 0^{th} to 7^{th} bodies B[0] to B[7] of the command packet (COMMAND) may include data indicating a type of the command. In an embodiment, the zeroth to seventh bodies B[0] to B[7] of the command packet (COMMAND) may include data indicating that the command packet (COMMAND) is a program command, a read command, or an erase command.

In an embodiment, an SCA packet including bit values of the 0^{th} to 3^{rd} headers H[0] to H[3] corresponding to “0111” may correspond to a non-target ODT command packet (NON TARGET ODT (NTO)). The non-target ODT command packet (NON TARGET ODT (NTO)) may be a packet that enables or disables multiple on-die termination circuits, each included in the nonvolatile memory devices.

In an embodiment, an SCA packet including bit values of the 0^{th} to 3^{rd} headers H[0] to H[3] corresponding to “1110” may correspond to a select chip enable command (SELECT CHIP ENABLE (SCE)). The select chip enable command (SELECT CHIP ENABLE (SCE)) may be a command that instructs data output. The zeroth to seventh bodies B[0] to B[7] of the select chip enable command (SELECT CHIP ENABLE (SCE)) may include information about a nonvolatile memory device to which the select chip enable command (SELECT CHIP ENABLE (SCE)) will be transmitted.

In an embodiment, an SCA packet including bit values of the 0^{th} to 3^{rd} headers H[0] to H[3] corresponding to “1101” may correspond to a select chip pause command (SELECT CHIP PAUSE (SCP)). In an embodiment, the select chip pause command (SELECT CHIP PAUSE (SCP)) may be a command that pauses data output. In an embodiment, the zeroth to seventh bodies B[0] to B[7] of the select chip pause command (SELECT CHIP PAUSE (SCP)) may include information about a nonvolatile memory device to which the select chip pause command (SELECT CHIP PAUSE (SCP)) will be transmitted.

In an embodiment, an SCA packet including bit values of the 0^{th} to 3^{rd} headers H[0] to H[3] corresponding to “1111” may correspond to a select chip terminate command (SELECT CHIP TERMINATE (SCT)). In an embodiment, a select chip terminate command (SELECT CHIP TERMINATE (SCT)) may be a packet that terminates data output of a nonvolatile memory device. In an embodiment, the zeroth to seventh bodies B[0] to B[7] of the select chip terminate command (SELECT CHIP TERMINATE (SCT)) may include information about a nonvolatile memory device to which the select chip terminate command (SELECT CHIP TERMINATE (SCT)) will be transmitted.

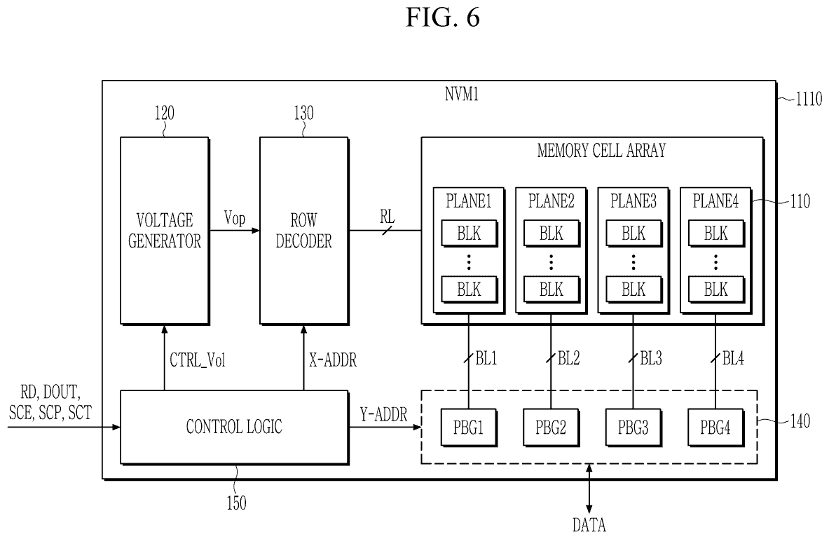

FIG. 6 illustrates a view for describing a nonvolatile memory device according to an embodiment.

Referring to FIG. 6, the first nonvolatile memory device 1110 may include a memory cell array 110, a voltage generator 120, a row decoder 130, a page buffer group 140, and a control logic 150.

In an embodiment, the memory cell array 110 may include first to fourth planes PLANE1 to PLANE4. In an embodiment, the first to fourth planes PLANE1 PLANE4 may each include a plurality of memory blocks BLK1 to BLKz. The memory blocks BLK1 to BLKz may be connected to the row decoder 130 through row lines RL. The memory blocks BLK1 to BLKz may be connected to the page buffer group 140 through the bit lines BL.

In an embodiment, each of the memory blocks BLK1 to BLKz may include a plurality of pages. The pages may each include a plurality of memory cells. In an embodiment, the memory cells may be nonvolatile memory cells. In an embodiment, the memory cells may store data received from the storage controller 1200.

In an embodiment, the voltage generator 120 may generate operating voltages Vop using an external power voltage supplied to the first nonvolatile memory device 1110. The voltage generator 120 may operate in response to the control logic 150.

In an embodiment, the voltage generator 120 may generate the operating voltages Vop used for program operations, read operations, and erase operations. For example, the voltage generator 120 may generate a program voltage, a pass voltage, a read voltage, and an erase voltage. The operating voltages Vop may be supplied to the memory cell array 110 by the row decoder 130.

In an embodiment, the row decoder 130 may be connected to the memory cell array 110 via the row lines RL. The row lines RL may include string selection lines, word lines, and ground selection lines.

In an embodiment, the row decoder 130 may be configured to operate in response to control of the control logic 150. The low decoder 130 may receive a low address X_ADDR from the control logic 150. In an embodiment, the row decoder 130 may select at least one word line among the word lines based on the row address X_ADDR, and may apply the operating voltages Vop provided from the voltage generator 120 to at least one word line.

In an embodiment, the row decoder 130 may apply a program voltage to a selected word line among the word lines during the program operation, and may apply a pass voltage at a level lower than the program voltage to unselected word lines. The row decoder 130 may apply a verification voltage to a selected word line during a program verification operation and apply a verification pass voltage at a level that is higher than a verification voltage to the unselected word lines.

In an embodiment, the row decoder 130 may apply the read voltage to the selected word line during the read operation, and may apply the read pass voltage at a level higher than the read voltage to the unselected word lines.

In an embodiment, the page buffer group 140 may include first to fourth page buffer groups PBG1 to PBG4. The first to fourth page buffer groups PBG1-PBG4 may each include a plurality of page buffers. The first to fourth page buffer groups PB1 to PB4 may be connected to the first to fourth planes PLANE1 to PLANE4, respectively. The first to fourth page buffer groups PBG1 to PBG4 may be respectively connected to a plurality of memory cells included in the memory cell array 110 through bit lines BL1 to BL4. The first to fourth page buffer groups PBG1 to PBG4 may operate in response to the control of control logic 150.

In an embodiment, the first to fourth page buffer groups PBG1 to PBG4 may receive data (DATA) from the storage controller 1200. The first to fourth page buffer groups PBG1 to PBG4 may select at least one bit line among the bit lines BL1 to BL4 based on the column address Y_ADDR received from the control logic 150.

In an embodiment, the first to fourth page buffer groups PBG1 to PBG4 may transmit data received from the outside (e.g., the storage controller 1200) to a plurality of memory cells of the memory cell array 110 through bit lines BL1 to BL4 during a program operation. The memory cells may be programmed according to received data. The first to fourth page buffer groups PBG1 to PBG4 my sense data stored in the memory cells through bit lines BL1 to BL4 during a program verification operation.

In an embodiment, the first to fourth page buffer groups PBG1 to PBG4 may sense data stored in memory cells through the bit lines BL1 to BL4 during a read operation, and store the sensed data in the first to fourth page buffer groups PBG1 to PBG4.

In an embodiment, the control logic 150 may be connected to the voltage generator 120, the row decoder 130, and the page buffer group 140.

In an embodiment, the control logic 150 may control an overall operation of the first nonvolatile memory device 1110. The control logic 150 may receive a command from the storage controller 1200 through the command/address line CA and control the voltage generator 120, the row decoder 130, and the page buffer group 140 to perform an operation corresponding to the command.

In an embodiment, the control logic 150 may control the first to fourth page buffer groups PBG1 to PBG4 to sense data stored in the first to fourth planes PLANE1 to PLANE4 to the first to fourth page buffer groups PBG1 to PBG4 in response to a read command RD received from the storage controller 1200. In an embodiment, in response to the read command, the first page buffer group PBG1 may sense first data stored in the first plane PLANE1, the second page buffer group PBG2 may sense second data stored in the second plane PLANE2, the third page buffer group PBG3 may sense third data stored in the third plane PLANE3, and the fourth page buffer group PBG4 may sense fourth data stored in the fourth plane PLANE4.

In an embodiment, the control logic 150 may determine some or all of first to fourth data to be output in response to a data output command DOUT received from the storage controller 1200.

In an embodiment, the control logic 150 may control the page buffer group 140 to output data stored in one page buffer group connected to one of the first to fourth planes PLANE1 to PLANE4 via the data line DQ in response to a select chip enable command SCE received from the storage controller 1200.

In an embodiment, the control logic 150 may control the page buffer group 140 to pause output of data stored in one page buffer group connected to one plane in response to a select chip pause command SCP received from the storage controller 1200. Although the term ‘pause’ is used in the select chip pause command SCP, the command may or may not actually pause data output from any memory plane.

In an embodiment, the control logic 150 may control the page buffer group 140 to pause outputting data stored in one page buffer group connected to one plane and outputting data stored in another page buffer group connected to another plane to the storage controller 1200 in response to a select chip pause/enable command received from the storage controller 1200.

In an embodiment, the control logic 150 may terminate data output of the first nonvolatile memory device 1110 in response to a select chip termination command SCT received from the storage controller 1200.

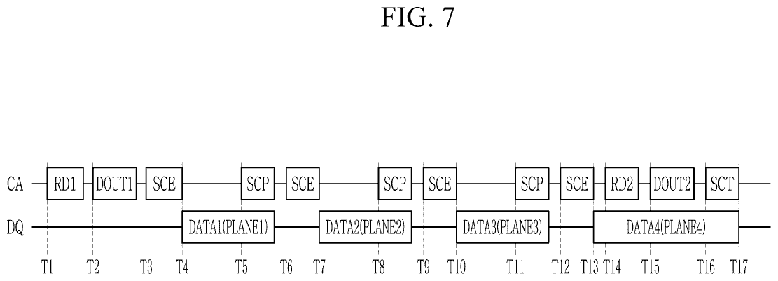

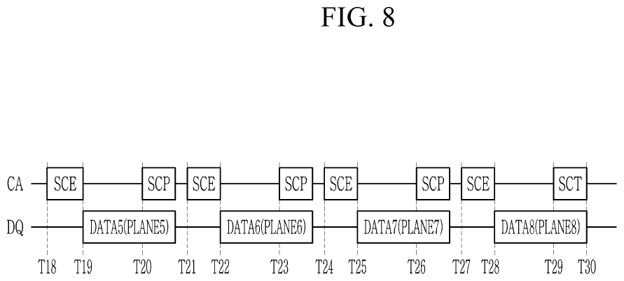

FIG. 7 and FIG. 8 each illustrate a data output operation using a select chip enable command and a select chip pause command according to an embodiment.

First, referring to FIG. 7, at T1, the storage controller 1200 may provide a first read command RD1 to the first nonvolatile memory device 1110. In an embodiment, the first read command RD1 may be a command to read data stored in the first to fourth planes PLANE1 to PLANE4 included in the first nonvolatile memory device 1110. In an embodiment, the first nonvolatile memory device 1110 may store data stored in the first to fourth planes PLANE1 to PLANE4 in the first to fourth page buffer groups PBG1 to PBG4 in response to the first read command RD1.

In an embodiment, at T2, the storage controller 1200 may provide a first data output command DOUT1 to the first nonvolatile memory device 1110.

In an embodiment, at T3, the storage controller 1200 may provide the select chip enable command SCE to the first nonvolatile memory device 1110.

In an embodiment, at T4, the first nonvolatile memory device 1110 may output first data (DATA1) of the first plane PLANE1 to the storage controller 1200 in response to the select chip enable command SCE.

In an embodiment, at T5, the storage controller 1200 may provide the select chip pause command SCP to the first nonvolatile memory device 1110 via the command/address line CA while receiving the first data (DATA1) from the first nonvolatile memory device 1110 via the data line DQ. In an embodiment, the first nonvolatile memory device 1110 may pause outputting the first data (DATA1) of the first plane PLANE1 in response to the select chip pause command SCP.

In an embodiment, at T6, the storage controller 1200 may provide the select chip enable command SCE to the first nonvolatile memory device 1110.

In an embodiment, at T7, the first nonvolatile memory device 1110 may output second data (DATA2) of the second plane PLANE2 to the storage controller 1200 in response to the select chip enable command SCE.

In an embodiment, at T8, the storage controller 1200 may provide the select chip pause command SCP to the first nonvolatile memory device 1110 via the command/address line CA while receiving the second data (DATA2) from the first nonvolatile memory device 1110 via the data line DQ. In an embodiment, the first nonvolatile memory device 1110 may pause outputting the second data (DATA2) of the second plane PLANE2 in response to the select chip pause command SCP.

In an embodiment, at T9, the storage controller 1200 may provide the select chip enable command SCE to the first nonvolatile memory device 1110.

In an embodiment, at T10, the first nonvolatile memory device 1110 may output third data (DATA3) of the third plane PLANE3 to the storage controller 1200 in response to the select chip enable command SCE.

In an embodiment, at T11, the storage controller 1200 may provide the select chip pause command SCP to the first nonvolatile memory device 1110 via the command/address line CA while receiving the third data (DATA3) from the first nonvolatile memory device 1110 via the data line DQ. In an embodiment, the first nonvolatile memory device 1110 may pause outputting the third data (DATA3) of the third plane PLANE3 in response to the select chip pause command SCP.

In an embodiment, at T12, the storage controller 1200 may provide the select chip enable command SCE to the first nonvolatile memory device 1110.

In an embodiment, at T13, the first nonvolatile memory device 1110 may output fourth data (DATA4) of the fourth plain PLANE4 to the storage controller 1200 in response to the select chip enable command SCE.

In an embodiment, at T14, the storage controller 1200 may provide a second read command RD2 to a second nonvolatile memory device 1120 via the command/address line CA while receiving the fourth data (DATA4) from the first nonvolatile memory device 1110 via the data line DQ. In an embodiment, the second nonvolatile memory device 1120 may read data stored in the fifth to eighth planes PLANE5 to PLANE8 in response to the second read command RD2.

In an embodiment, at T15, the storage controller 1200 may provide a second data output command DOUT2 to the second nonvolatile memory device 1120.

In an embodiment, at T16, the storage controller 1200 may provide the select chip terminate SCT to the first nonvolatile memory device 1110.

In an embodiment, at T17, the first nonvolatile memory device 1110 may terminate an output of fourth data (DATA4) in response to a select chip terminate command SCT.

Next, referring to FIG. 8, at T18, the storage controller 1200 may provide a select chip enable command SCE to the second nonvolatile memory device 1120.

In an embodiment, at T19, the second nonvolatile memory device 1120 may output fifth data (DATA5) of the fifth plane PLANE5 to the storage controller 1200 in response to the select chip enable command SCE.

In an embodiment, at T20, the storage controller 1200 may provide the select chip pause command SCP to the second nonvolatile memory device 1120 via the command/address line CA while receiving the fifth data (DATA5) from the second nonvolatile memory device 1120 via the data line DQ. In an embodiment, the second nonvolatile memory device 1120 may pause outputting the fifth data (DATA5) in response to the select chip pause command SCP.

In an embodiment, at T21, the storage controller 1200 may provide the select chip enable command SCE to the second nonvolatile memory device 1120.

In an embodiment, at T22, the second nonvolatile memory device 1120 may output sixth data (DATA6) of the sixth plane PLANE6 to the storage controller 1200 in response to the select chip enable command SCE.

In an embodiment, at T23, the storage controller 1200 may provide the select chip pause command SCP to the second nonvolatile memory device 1120 via the command/address line CA while receiving the sixth data (DATA6) from the second nonvolatile memory device 1120 via the data line DQ. In an embodiment, the second nonvolatile memory device 1120 may pause outputting the sixth data (DATA6) in response to the select chip pause command SCP.

In an embodiment, at T24, the storage controller 1200 may provide the select chip enable command SCE to the second nonvolatile memory device 1120.

In an embodiment, at T25, the second nonvolatile memory device 1120 may output seventh data (DATA7) of the seventh plane PLANE7 to the storage controller 1200 in response to the select chip enable command SCE.

In an embodiment, at T26, the storage controller 1200 may provide the select chip pause command SCP to the second nonvolatile memory device 1120 via the command/address line CA while receiving the seventh data (DATA7) from the second nonvolatile memory device 1120 via the data line DQ. In an embodiment, the second nonvolatile memory device 1120 may pause outputting the seventh data (DATA7) in response to the select chip pause command SCP.

In an embodiment, at T27, the storage controller 1200 may provide the select chip enable command SCE to the second nonvolatile memory device 1120.

In an embodiment, at T28, the second nonvolatile memory device 1120 may output eighth data (DATA8) of the eighth plane PLANE8 to the storage controller 1200 in response to the select chip enable command SCE.

In an embodiment, at T29, the storage controller 1200 may provide the select chip terminate command SCT to the second nonvolatile memory device 1120 via the command/address line CA while receiving the eighth data (DATA8) from the second nonvolatile memory device 1120 via the data line DQ.

In an embodiment, at T30, the second nonvolatile memory device 1120 may terminate an output of the eighth data (DATA8) in response to a select chip terminate command SCT.

In an embodiment, the storage controller 1200 may sequentially provide the select chip pause command SCP and the select chip enable command SCE to the first nonvolatile memory device 1110 or the second nonvolatile memory device 1120 to pause data output of one plane and instruct data output of another plane.

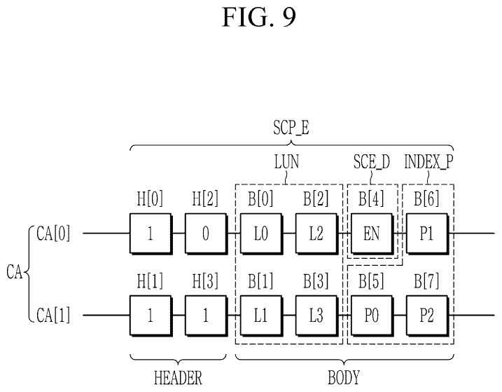

FIG. 9 illustrate a view for describing a select chip pause/enable command according to an embodiment.

Referring to FIG. 9, the storage controller 1200 may provide a select chip pause/enable SCP_E command to the first nonvolatile memory device 1110. In an embodiment, the select chip pause/enable command SCP_E may be a command that pauses data output of one plane included in the non-volatile memory device and instructs data output of another plane.

In an embodiment, the select chip pause/enable command SCP_E may include header data HEADER and body data BODY. In an embodiment, the header data HEADER may include data that pauses data output. In an embodiment, bit values of the 0^{th} to 3^{rd} headers H[0] to H[3] may correspond to “1101”.

In an embodiment, the body data BODY may include a logical unit number (LUN) for selecting a nonvolatile memory device, select chip enable data SCE_D for instructing data output, and a plane index INDEX_P for selecting a plane to output data.

In an embodiment, the zeroth to third bodies B[0] to B[3] may include a LUN relating to a non-volatile memory device that provides a select chip pause/enable command.

In an embodiment, the fourth body B[4] may be the select chip enable data SCE_D that instructs data output. In an embodiment, when a bit value of the fourth body corresponds to “1”, the fourth body B[4] may be data indicating that data will be output.

In an embodiment, the fifth to seventh bodies B[5] to B[7] may be plane indices INDEX_P that select a plane to output data. In an embodiment, the fifth to seventh bodies B[5] to B[7] may include indices related to planes that are the targets for outputting data among multiple planes.

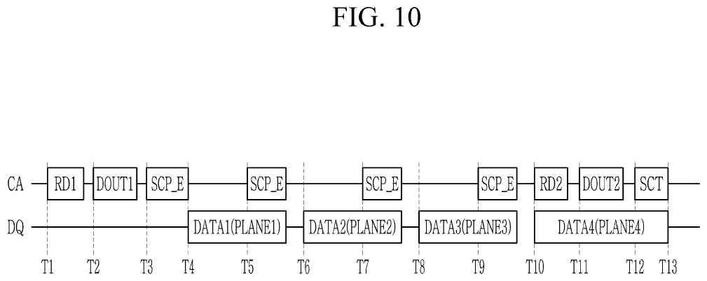

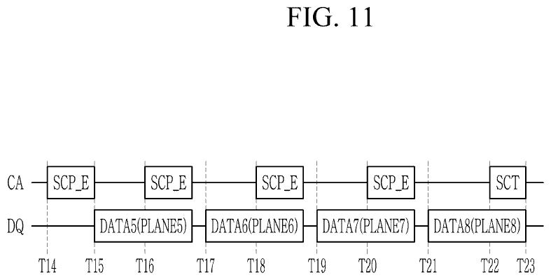

FIG. 10 and FIG. 11 each illustrate a view for describing a data output operation using a select chip pause/enable command according to an embodiment.

First, referring to FIG. 10, at T1, the storage controller 1200 may provide a first read command RD1 to the first nonvolatile memory device 1110. In an embodiment, the first nonvolatile memory device 1110 may sense first to fourth data DATA1 to DATA4 stored in the first to fourth planes PLANE1 to PLANE4 in the first to fourth page buffer groups PBG1 to PBG4 in response to the first read command RD1.

In an embodiment, at T2, the storage controller 1200 may provide a first data output command DOUT1 to the first nonvolatile memory device 1110.

In an embodiment, at T3, the storage controller 1200 may provide the select chip pause/enable command SCP_E to the first nonvolatile memory device 1110. In an embodiment, at T3, the select chip pause/enable command SCP_E may include a LUN for selecting the first nonvolatile memory device 1110, select the chip enable data SCE_D for instructing data output, and a first plane index for selecting a first plane to output data.

In an embodiment, at T4, the first nonvolatile memory device 1110 may output first data (DATA1) of the first plane PLANE1 to the storage controller 1200 in response to the select chip pause/enable command SCP_E. In an embodiment, the first nonvolatile memory device 1110 may select the first plane PLANE1 to output data based on a first plane index included in the select chip pause/enable command. In an embodiment, the first nonvolatile memory device 1110 may output first data (DATA1) stored in the first page buffer group PBG1 connected to the first plane PLANE1 to the storage controller 1200 based on the select chip enable data SCE_D included in the select chip pause/enable command SCP_E.

In an embodiment, at T5, the storage controller 1200 may provide the select chip pause/enable command SCP_E to the first nonvolatile memory device 1110 via the command/address line CA while receiving the first data (DATA1) from the first nonvolatile memory device 1110 via the data line DQ. In an embodiment, at T5, the select chip pause/enable command SCP_E may include a second plane index that selects the second plane PLANE2 to output data.

In an embodiment, the first nonvolatile memory device 1110 may pause an output of the first data (DATA1) from the first plane PLANE1 in response to the select chip pause/enable command SCP_E, and may output the second data (DATA2) from the second plane PLANE2 to the storage controller 1200.

In an embodiment, the first nonvolatile memory device 1110 may pause an output of the first data (DATA1) stored in the first page buffer group PBG1 connected to the first plane (PLANE1) based on the header data HEADER included in the select chip pause/enable command SCP_E.

In an embodiment, the first nonvolatile memory device 1110 may select the second plane PLANE2 to output data based on a second plane index included in the select chip pause/enable command SCP_E.

In an embodiment, the first nonvolatile memory device 1110 may output second data (DATA2) stored in the second page buffer group PBG2 connected to the second plane PLANE2 to the storage controller 1200 based on the select chip enable data SCE_D included in the select chip pause/enable command SCP_E. In an embodiment, at T6, the first nonvolatile memory device 1110 may output second data (DATA2) of the second plane PLANE2 to the storage controller 1200.

In an embodiment, at T7, the storage controller 1200 may provide the select chip pause/enable command SCP_E to the first nonvolatile memory device 1110 while receiving the second data (DATA2) from the first nonvolatile memory device 1110. In an embodiment, at T7, the select chip pause/enable command SCP_E may include a third plane index that selects the third plane PLANE3 to output data.

In an embodiment, the first nonvolatile memory device 1110 may pause an output of the second data (DATA2) from the second plane PLANE2 in response to the select chip pause/enable command SCP_E, and may output the third data (DATA3) from the third plane PLANE3 to the storage controller 1200.

In an embodiment, the first nonvolatile memory device 1110 may pause the output of the second data (DATA2) stored in the second page buffer group PBG2 connected to the second plane PLANE2 based on the header data HEADER included in the select chip pause/enable command SCP_E. In an embodiment, the first nonvolatile memory device 1110 may select the third plane PLANE3 to output data based on a third plane index included in the select chip pause/enable command SCP_E.

In an embodiment, the first nonvolatile memory device 1110 may output third data (DATA3) stored in the third page buffer group PBG3 connected to the third plane PLANE3 to the storage controller 1200 based on the select chip enable data SCE_D included in the select chip pause/enable command SCP_E. In an embodiment, at T8, the first nonvolatile memory device 1110 may output third data (DATA3) of the third plane PLANE3 to the storage controller 1200.

In an embodiment, at T9, the storage controller 1200 may provide the select chip pause/enable command SCP_E to the first nonvolatile memory device 1110 while receiving the third data (DATA3) from the first nonvolatile memory device 1110. In an embodiment, at T9, the select chip pause/enable command SCP_E may include a fourth plane index that selects the fourth plane PLANE4 to output data.

In an embodiment, the first nonvolatile memory device 1110 may pause an output of the third data (DATA3) from the fourth plane PLANE3 in response to the select chip pause/enable command SCP_E, and may output the fourth data (DATA4) from the fourth plane PLANE4 to the storage controller 1200. In an embodiment, the first nonvolatile memory device 1110 may pause the output of the third data (DATA3) stored in the third page buffer group PBG3 connected to the third plane PLANE3 based on the header data HEADER. In an embodiment, the first nonvolatile memory device 1110 may select the fourth plane PLANE4 to output data based on a fourth plane index. In an embodiment, the first nonvolatile memory device 1110 may output the fourth data (DATA4) stored in the fourth page buffer group PBG4 connected to the fourth plane PLANE4 to the storage controller 1200 based on the select chip enable data SCE_D. In an embodiment, at T10, the first nonvolatile memory device 1110 may output the fourth data (DATA4) to the storage controller 1200.

In an embodiment, at T10, the storage controller 1200 may provide the second read command RD2 to the second nonvolatile memory device 1120 while receiving the fourth data (DATA4) from the first nonvolatile memory device 1110. In an embodiment, the second nonvolatile memory device 1120 may read data stored in the fifth to eighth planes PLANE5 to PLANE8 in response to the second read command RD2.

In an embodiment, at T11, the storage controller 1200 may provide a second data output command DOUT2 to the second nonvolatile memory device 1120.

In an embodiment, at T12, the storage controller 1200 may provide the select chip terminate SCT to the first nonvolatile memory device 1110.

In an embodiment, at T13, the first nonvolatile memory device 1110 may terminate an output of fourth data (DATA4) in response to a select chip terminate command SCT.

Next, referring to FIG. 11, at T14, the storage controller 1200 may provide a select chip pause/enable command SCP_E to the second nonvolatile memory device 1120. In an embodiment, at T14, the select chip pause/enable command (SCP_E) may include a LUN that selects the second nonvolatile memory device 1120. In an embodiment, at T14, the select chip pause/enable command SCP_E may include a fifth plane index that selects the fifth plane PLANE5.

In an embodiment, at T15, the second nonvolatile memory device 1120 may output fifth data (DATA5) of the fifth plane PLANE5 to the storage controller 1200 in response to the select chip pause/enable command SCP_E.

In an embodiment, at T16, the storage controller 1200 may provide the select chip pause/enable command SCP_E to the second nonvolatile memory device 1120. In an embodiment, at T16, the select chip pause/enable command SCP_E may include a sixth plane index that selects the sixth plane PLANE6.

In an embodiment, the second nonvolatile memory device 1120 may pause an output of the fifth data (DATA5) from the fifth plane PLANE5 in response to the select chip pause/enable command SCP_E, and may output fourth data (DATA6) from the fourth plane PLANE6 to the storage controller 1200. In an embodiment, at T17, the second nonvolatile memory device 1120 may output the sixth data (DATA6) to the storage controller 1200.

In an embodiment, at T18, the storage controller 1200 may provide the select chip pause/enable command SCP_E to the second nonvolatile memory device 1120. In an embodiment, at T18, the select chip pause/enable command SCP_E may include a seventh plane index that selects the seventh plane PLANE7.

In an embodiment, the second nonvolatile memory device 1120 may pause an output of the sixth data (DATA6) from the sixth plane PLANE6 in response to the select chip pause/enable command SCP_E, and may output seventh data (DATA7) from the seventh plane PLANE7 to the storage controller 1200. In an embodiment, at T19, the second nonvolatile memory device 1120 may output the seventh data (DATA7) to the storage controller 1200.

In an embodiment, at T20, the storage controller 1200 may provide the select chip pause/enable command SCP_E to the second nonvolatile memory device 1120. In an embodiment, at T20, the select chip pause/enable command SCP_E may include a eighth plane index that selects the eighth plane PLANE8.

In an embodiment, the second nonvolatile memory device 1120 may pause an output of the seventh data (DATA7) from the seventh plane PLANE7 in response to the select chip pause/enable command SCP_E, and may output eighth data (DATA8) from the eighth plane PLANE8 to the storage controller 1200. In an embodiment, at T21, the second nonvolatile memory device 1120 may output the eighth data (DATA8) to the storage controller 1200.

In an embodiment, at T22, the storage controller 1200 may provide the select chip terminate SCT to the second nonvolatile memory device 1120.

In an embodiment, at T23, the second nonvolatile memory device 1120 may terminate an output of the eighth data (DATA8) in response to a select chip terminate command SCT.

In an embodiment, the storage device 1000 may reduce a time required for data output by using the select chip pause/enable command SCP_E instead of the select chip pause command SCP and a select chip enable command SCE to pause data output of one plane and instruct data output of another plane.

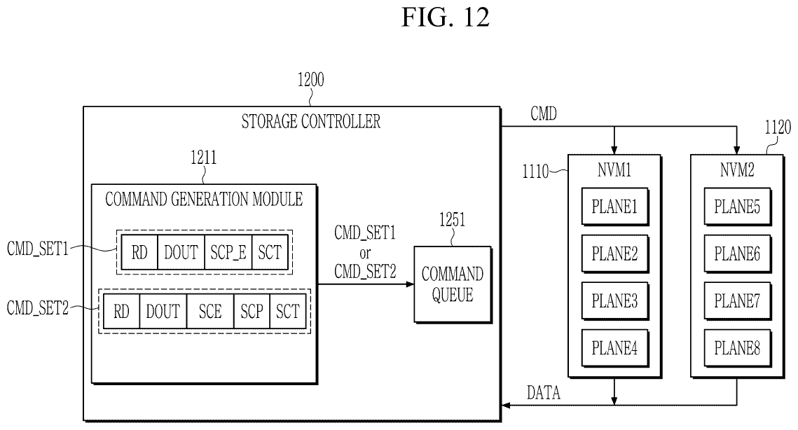

FIG. 12 illustrates a view for describing a storage controller that generates a first command set or a second command set according to an embodiment.

Referring to FIG. 12, the command generation module 1211 may determine a mode of a read operation based on a read request received from the host 2000. In an embodiment, the command generation module 1211 may determine the mode of the read operation as a sequential read mode when logical addresses received from the host 2000 correspond to consecutive addresses. In an embodiment, the command generation module 1211 may determine the mode of the read operation as the sequential read mode when the physical addresses of the nonvolatile memory device corresponding to data to be read correspond to the consecutive addresses.

In an embodiment, the command generation module 1211 may determine the mode of the read operation as a random read mode when logical addresses received from the host 2000 correspond to non-consecutive addresses. In an embodiment, the command generation module 1211 may determine the mode of the read operation as the random read mode when the physical addresses of the nonvolatile memory device corresponding to data to be read correspond to the non-consecutive addresses.

In an embodiment, the command generation module 1211 may generate a first command set CMD_SET1 or a second command set CMD_SET2 based on the mode of the lead operation.

In an embodiment, the command generation module 1211 may generate the first command set CMD_SET1 when the mode of the read operation corresponds to the sequential read mode. In an embodiment, the first command set CMD_SET1 may include the read command RD, the data output command DOUT, the select chip pause/enable command SCP_E, and the select chip terminate command SCT. In an embodiment, the storage controller 1200 may use the select chip pause/enable command SCP_E in the sequential read mode to pause data output of one plane and instruct data output of another plane.

In an embodiment, the command generation module 1211 may generate the second command set CMD_SET2 when the mode of the read operation corresponds to the random read mode. In an embodiment, the second command set CMD_SET2 may generate the read command RD, the data output command DOUT, the select chip enable command SCE, the select chip pause command SCP, and the select chip terminate command SCT. In an embodiment, the storage controller 1200 may pause data output of one plane using the select chip pause command SCP in the random read mode, and may instruct data output of another plane using the select chip enable command SCE.

In an embodiment, the command generation module 1211 may provide the first command set CMD_SET1 or the second command set CMD_SET2 to the command queue 1251. In an embodiment, the command queue 1251 may provide the first command set CMD_SET1 or the second command set CMD_SET2 to the first nonvolatile memory device 1110 or the second nonvolatile memory device 1120.

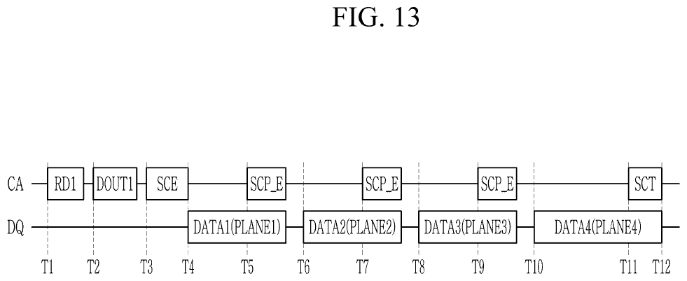

FIG. 13 illustrates a data output operation using a select chip enable command and a select chip pause/enable command according to an embodiment.

In FIG. 13, an example of performing the read operation on the first nonvolatile memory device 1110 is described.

Referring to FIG. 13, the storage controller 1200 may provide a first read command RD1 and a first data output command DOUT1 to the first nonvolatile memory device 1110.

In an embodiment, at T3, the storage controller 1200 may provide the select chip enable command SCE to the first nonvolatile memory device 1110 instead of the select chip pause/enable command SCP_E. In an embodiment, at T3, the select chip enable command SCE may be a command that instructs data output of the first plane PLANE1. In an embodiment, the select chip enable command SCE may include a first plane index that selects the first plane PLANE1 for outputting data.

In an embodiment, at T4, the first nonvolatile memory device 1110 may output first data (DATA1) of the first plane PLANE1 to the storage controller 1200 in response to the select chip enable command SCE.

In an embodiment, at T5, the storage controller 1200 may provide the select chip pause/enable command SCP_E. In an embodiment, the first nonvolatile memory device 1110 may pause an output of the first data (DATA1) from the first plane PLANE1 in response to the select chip pause/enable command SCP_E, and may output the second data (DATA2) from the second plane PLANE2 to the storage controller 1200.

In an embodiment, at T7, the storage controller 1200 may provide the select chip pause/enable command SCP_E. In an embodiment, the first nonvolatile memory device 1110 may pause an output of the second data (DATA2) from the second plane PLANE2 in response to the select chip pause/enable command SCP_E, and may output the third data (DATA3) from the third plane PLANE3 to the storage controller 1200.

In an embodiment, at T9, the storage controller 1200 may provide the select chip pause/enable command SCP_E. In an embodiment, the first nonvolatile memory device 1110 may pause an output of the third data (DATA3) from the fourth plane PLANE3 in response to the select chip pause/enable command SCP_E, and may output the fourth data (DATA4) from the fourth plane PLANE4 to the storage controller 1200.

In an embodiment, at T11, the storage controller 1200 may provide the select chip terminate SCT to the first nonvolatile memory device 1110.

In an embodiment, at T12, the first nonvolatile memory device 1110 may terminate an output, of fourth data (DATA4) in response to a select chip terminate command SCT.

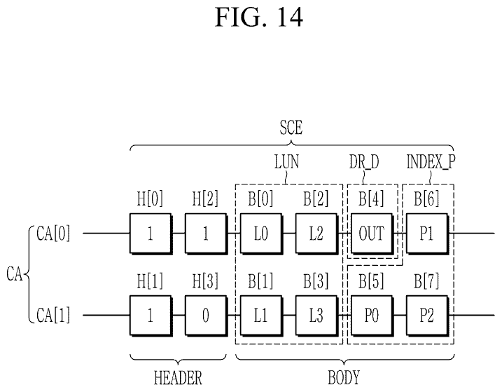

FIG. 14 illustrate a view for describing a select chip enable command according to an embodiment.

Referring to FIGS. 13 and 14, the select chip enable command (SCE) may be a command that instructs data output of one plane. In an embodiment, the select chip enable command SCE may include header data HEADER and body data BODY. In an embodiment, the header data HEADER may include data that instructs data output. In an embodiment, bit values of the 0^{th} to 3^{rd} headers H[0] to H[3] may correspond to “1110”.

In an embodiment, the body data BODY may include a LUN for selecting a nonvolatile memory device, direction data DR_D for indicating a direction in which data is output or input, and a plane index INDEX_P for selecting a plane to output data. In an embodiment, the direction data DR_D may include output data OUT indicating that data is output from a nonvolatile memory device to the storage controller 1200, or input data indicating that data is input from a storage controller 1200 to the nonvolatile memory device. In an embodiment, when a bit value of the direction data DR_D corresponds to “0”, the direction data DR_D may correspond to the output data OUT. In an embodiment, when the bit value of the direction data DR_D corresponds to “1”, the direction data DR_D may correspond to the input data.

In an embodiment, the fourth body B[4] may be the direction data DR_D. In an embodiment, the fourth body B[4] may include output data OUT indicating that data is output from the nonvolatile memory device to the storage controller 1200. In an embodiment, a bit value of the fourth body B[4] may correspond to “0”. In an embodiment, the fifth to seventh bodies B[5] to B[7] may be plane indices INDEX_P that select a plane to output data.

In an embodiment, the first nonvolatile memory device 1110 may select the first plane PLANE1 to output data based on the first plane index included in the select chip enable command SCE received from the storage controller 1200, and may output first data (DATA1) of the first plane PLANE1 to the storage controller 1200 based on the header data HEADER and the direction data DR_D included in the select chip enable command SCE.

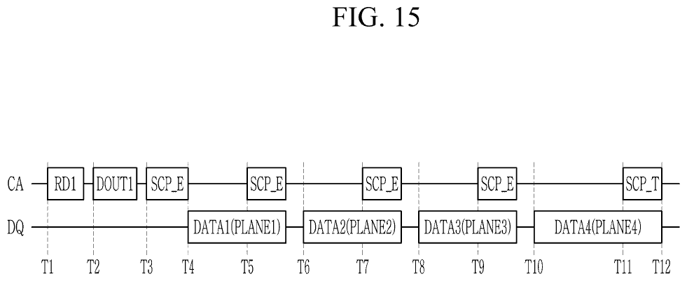

FIG. 15 illustrates a data output operation using a select chip pause/enable command and a select chip pause/terminate command according to an embodiment.

In FIG. 15, an example of performing the read operation on the first nonvolatile memory device 1110 is described.

Referring to FIG. 15, the storage controller 1200 may provide a first read command RD1 and a first data output command DOUT1 to the first nonvolatile memory device 1110.

In an embodiment, at T3, the storage controller 1200 may provide the select chip pause/enable command SCP_E. In an embodiment, the first nonvolatile memory device 1110 may output first data (DATA1) of the first plane PLANE1 to the storage controller 1200 in response to the select chip pause/enable command SCP_E.

In an embodiment, at T5, T7, and T9, the storage controller 1200 may provide the select chip pause/enable command SCP_E to the first nonvolatile memory device 1110. In an embodiment, the first nonvolatile memory device 1110 may pause the data output of one plane and output data from another plane to the storage controller 1200 in response to the select chip pause/enable command SCP_E.

In an embodiment, at T11, the storage controller 1200 may provide the select chip pause/terminate command SCP_T to the first nonvolatile memory device 1110 instead of the select chip terminate command SCT. In an embodiment, the select chip pause/terminate command SCP_T may include select chip terminate data that terminates data output of the first nonvolatile memory device 1110.

In an embodiment, at T12, the first nonvolatile memory device 1110 may terminate the data output in response to the select chip pause/terminate command SCP_T. In an embodiment, the first nonvolatile memory device 1110 may terminate the output of the fourth data (DATA4) from the fourth plane PLANE4.

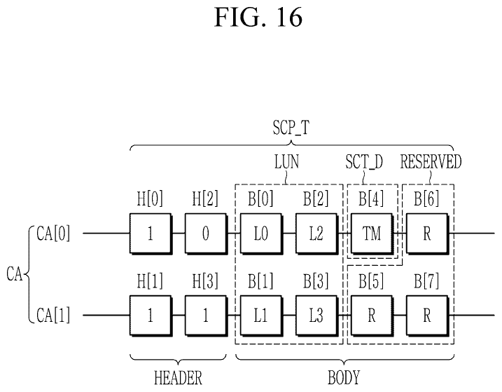

FIG. 16 illustrate a view for describing a select chip pause/terminate command according to an embodiment.

Referring to FIG. 16, the select chip pause/terminate command SCP_T may be a command that terminates data output of the nonvolatile memory device. In an embodiment, the select chip pause/terminate command SCP_T may include header data HEADER and body data BODY. In an embodiment, the header data HEADER may include data that pauses data output. In an embodiment, bit values of the 0^{th} to 3^{rd} headers H[0] to H[3] may correspond to “1101”.

The body data BODY may include the LUN that selects the nonvolatile memory device, the select chip terminate data SCT_D that terminates the data output, and reserved data RESERVED.

In an embodiment, the fourth body B[4] may be the select chip terminate data SCT_D that terminates data output of the nonvolatile memory device. In an embodiment, when a bit value of the fourth body corresponds to “0”, the fourth body B[4] may be data indicating that data output will be terminated.

In an embodiment, the fifth to seventh bodies B[5] to B[7] may reserve the reserved data RESERVED.

In an embodiment, the first nonvolatile memory device 1110 may pause output of the fourth data (DATA4) of the fourth plane PLANE4 based on the header data HEADER included in the selection chip pause/terminate command SCP_T received from the storage controller 1200, and may terminate data output of the first nonvolatile memory device 1110 based on the select chip terminate data SCT_D included in the select chip pause/terminate command SCP_T.

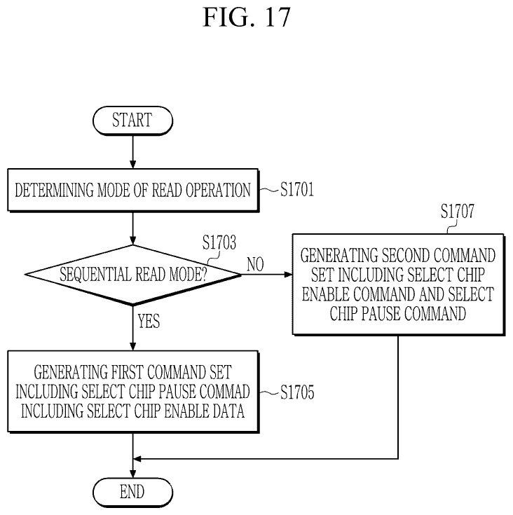

FIG. 17 illustrates a flowchart for describing a storage controller that generates a first command set or a second command set according to an embodiment.

Referring to FIG. 17, in S1701, the storage controller 1200 may determine a mode of a read operation. In an embodiment, the storage controller 1200 may determine the mode of the read operation as a sequential read mode or a random read mode based on logical addresses or physical addresses corresponding to data to be read.

In an embodiment, in S1703, the storage controller 1200 may identify whether the mode of the read operation is a sequential read mode. In an embodiment, when the mode of the lead operation is the sequential read mode, S1705 may be performed. In an embodiment, if the mode of the lead operation is the random lead mode, S1707 may be performed.

In an embodiment, in S1705, when the mode of the read operation is the sequential read mode, the storage controller 1200 may generate a first command set including a select chip pause command including select chip enable data. In an embodiment, the select chip pause command including the select chip enable data may be a command that pauses data output of one plane of a nonvolatile memory device and instructs data output of another plane. In an embodiment, the first command set may further include a read command, a data output command, and a select chip terminate command.

In an embodiment, in S1707, the storage controller 1200 may generate a second command set including a select chip enable command and a select chip pause command when the mode of the read operation is the random read mode. In an embodiment, the select chip pause command may be a command that pauses data output of one plane of a nonvolatile memory device. In an embodiment, the select chip enable command may be a command that instructs data output of another plane of a nonvolatile memory device. In an embodiment, the second command set may further include a read command, a data output command, and a select chip terminate command.

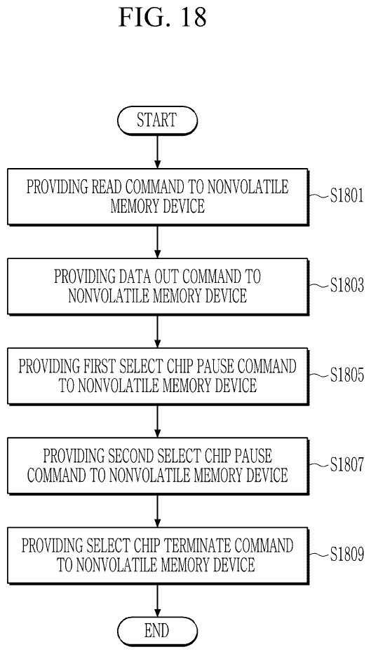

FIG. 18 illustrates a flowchart showing an operating method for a storage device according to an embodiment.

Referring to FIG. 18, in S1801, the storage controller 1200 may provide a read command to a nonvolatile memory device. In an embodiment, the nonvolatile memory device may sense data stored in multiple planes into multiple page buffers, respectively, in response to a read command.

In an embodiment, in S1803, the storage controller 1200 may provide a data output command to a nonvolatile memory device. In an embodiment, a nonvolatile memory device may determine which data to output from among sensed data in each of a plurality of page buffers in response to a data output command.

In an embodiment, in S1805, the storage controller 1200 may provide a first select chip pause command to a nonvolatile memory device. In an embodiment, the first select chip pause command may include select chip enable data indicating data output and a plane index selecting one plane to output data. In an embodiment, the nonvolatile memory device may output data stored in a page buffer connected to one plane corresponding to a plane index among a plurality of planes to the storage controller 1200 in response to a first select chip pause command.

In an embodiment, in S1807, the storage controller 1200 may provide a second select chip pause command to a nonvolatile memory device. In an embodiment, the second select chip pause command may include header data for pausing data output of one plane, select chip enable data for instructing data output of another plane, and a plane index for selecting another plane to output data. In an embodiment, a nonvolatile memory device may pause data output of one plane in response to a second select chip pause command, and may output data stored in a page buffer connected to another plane corresponding to a plane index among a plurality of planes to the storage controller 1200.

In an embodiment, in S1809, the storage controller 1200 may provide a select chip terminate command to a nonvolatile memory device. In an embodiment, a nonvolatile memory device may terminate data output in response to a select chip terminate command.

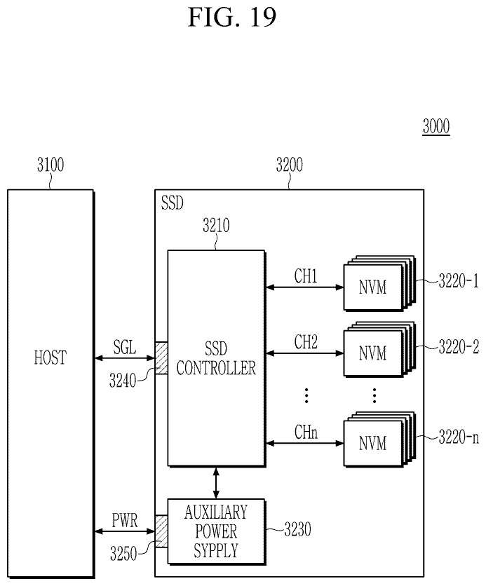

FIG. 19 illustrates a view for describing a storage system according to an embodiment.

Referring to FIG. 19, the storage system 3000 may include a host 3100 and a solid state drive (SSD) 3200.

In an embodiment, the SSD 3200 may include an SSD controller 3210, a plurality of non-volatile memory devices 3220-1 to 3220-n, and an auxiliary power supply 3230.

In an embodiment, the SSD controller 3210 may be connected to the non-volatile memory devices 3220-1 to 3220-n through a plurality of channels CH1 to CHn.

In an embodiment, the SSD controller 3210 may transmit and receive a signal SGL with the host 3100 through a signal connector 3240. In an embodiment, the signal SGL may include a command, an address, and data, etc. The SSD controller 3210 may store data in the non-volatile memory devices 3220-1 to 3220-n or read data stored in the non-volatile memory devices 3220-1 to 3220-n according to a command from the host 3100.

In an embodiment, the SSD controller 3210 may include the command generation module 1211 of FIG. 1. In an embodiment, the SSD controller 3210 may generate a select chip pause command that pauses data output of one plane among multiple planes of one nonvolatile memory device and instructs data output of another plane. In an embodiment, the select chip pause command may include header data for pausing data output, select chip enable data for instructing data output, and a plane index for selecting a plane to output data.

In an embodiment, the non-volatile memory devices 3220-1 to 3220-n may be used as a storage media of the SSD 3200. In an embodiment, a plurality of nonvolatile memory devices 323-1, 323-2, . . . , and 323-n may include a memory cell array. A memory cell array may include a plurality of memory cells that store data. In an embodiment, the nonvolatile memory devices 3220-1 to 3220-n may each include a plurality of planes.

In an embodiment, the auxiliary power supply 3230 may receive power PWR from the host 3100 through the power connector 3250 to supply power to the SSD controller 3210. In an embodiment, the auxiliary power supply 3230 may be positioned within the SSD 3200, or may be positioned external to the SSD 3200. In an embodiment, the auxiliary power supply 3230 may be positioned on s main board, and may provide auxiliary power to the SSD 3200.

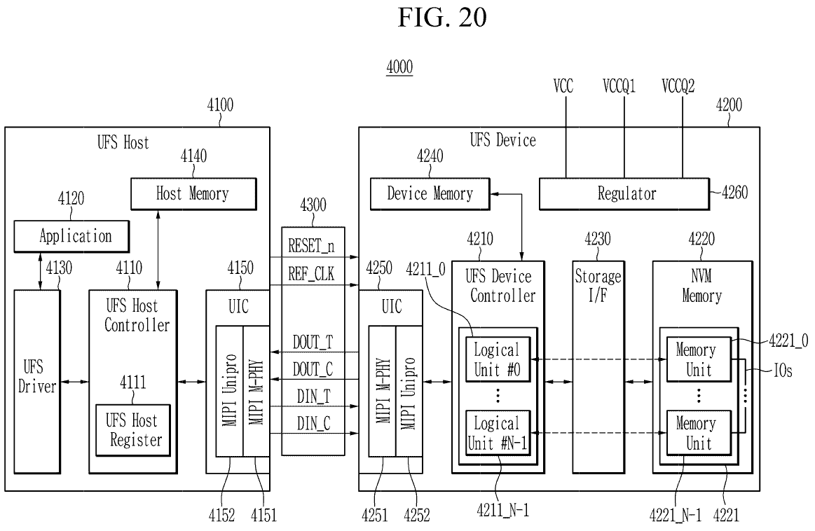

FIG. 20 illustrates a view for describing a universal flash storage (UFS) system according to an embodiment.

Referring to FIG. 20, a UFS system 4000 may include a UFS host 4100, a UFS device 4200, and a UFS interface 4300.

In an embodiment, the UFS host 4100 may include a UFS host controller 4110, an application 4120, a UFS driver 4130, a host memory 4140, and a UFS interconnect (UIC) layer 4150.

In an embodiment, the UFS device 4200 may include a UFS device controller 4210, a nonvolatile memory 4220, a storage interface 4230, a device memory 4240, a UIC layer 4250, and a regulator 4260. The nonvolatile memory 4220 may be formed of a plurality of memory units 4221_0 to 4221_(N-1), and the memory units 4221_0 to 4221_(N-1) may include a V-NAND flash memory having a 2D structure or a 3D structure, but may also include other types of nonvolatile memory such as a PRAM and/or a RRAM. The UFS device controller 4210 and the nonvolatile memory 4220 may be connected to each other via the storage interface 4230. This storage interface 4230 may be implemented to comply with a standard protocol such as Toggle or ONFI.

In an embodiment, the memory units 4221_0 to 4221_(N-1) may be implemented as a plurality of nonvolatile memory devices. Each of the memory units 4221_0 to 4221_(N-1) may include a memory cell array and a control circuit that controls an operation for the memory cell array. In an embodiment, the memory units 4221_0 to 4221_(N-1) may include a plurality of planes that perform an read operation or a program operation in parallel.

In an embodiment, the application 4120 may be a program that desires to communicate with the UFS device 4200 to utilize a function of the UFS device 4200. The application 4120 may transmit an input-output request (IOR) to the UFS driver 4130 for input/output to the UFS device 4200. In an embodiment, the input-output request (IOR) may indicate a request to read data, a request to write data, and/or a request to discard data.

In an embodiment, the UFS driver 4130 may manage the UFS host controller 4110 via a host controller interface (UFS-HCI). The UFS driver 4130 may convert an input-output request generated by the application 4120 into a UFS command defined by a UFS standard, and may transmit the converted UFS command to the UFS host controller 4110. A single I/O request may be translated into multiple UFS commands. The UFS command may primarily be defined by a SCSI standard, but it may also be specific to the UFS standard.

In an embodiment, the UFS host controller 4110 may transmit a UFS command converted by the UFS driver 4130 to the UIC layer 4250 of the UFS device 4200 via a UIC layer 4150 and the UFS interface 4300. In this process, a UFS host register 4111 of the UFS host controller 4110 may serve as a command queue CQ.

In an embodiment, the UIC layer 4150 on a side of the UFS host 4100 may include MIPI M-PHY 4151 and MIPI UniPro 4152, and the UIC layer 4250 on a side of the UFS device 4200 may also include MIPI M-PHY 4251 and MIPI UniPro 4252.

In an embodiment, the UFS interface 4300 may include a line for transmitting a reference clock REF_CLK, a line for transmitting a hardware reset signal RESET_n for the UFS device 4200, a pair of lines for transmitting a differential input signal pair DIN_t and DIN_c, and a pair of lines for transmitting a differential output signal pair DOUT_t and DOUT_c.

In an embodiment, the UFS interface 4300 may support multiple lanes, and each of the lanes may be implemented as a differential pair. For example, the UFS interface 4300 may include one or more receive lanes and one or more transmit lanes. The receive lanes and the transmit lanes may transmit data in a serial communication manner, and full-duplex communication between the UFS host 4100 and the UFS device 4200 may be possible due to a structure in which the receive lanes and the transmit lanes are separated.

In an embodiment, the UFS device controller 4210 of the UFS device 4200 may generally control an operation of the UFS device 4200. The UFS device controller 4210 may manage the nonvolatile memory 4220 through a logical unit (LU) 4211, which is a logical data storage unit. A number of LUs 4211 may be 4 or 8, but the present disclosure is not limited thereto. The UFS device controller 4210 may include a flash translation layer (FTL), and may convert a logical address transmitted from the UFS host 4100 into a physical address using address mapping information of the FTL. In the UFS system 4000, a logical block for storing user data may have a size within a predetermined range. For example, a minimum size of the logical block may be set to 4 Kbytes.

In an embodiment, when a command from the UFS host 4100 is input to the UFS device 4200 through the UIC layer 4250, the UFS device controller 4210 may perform an operation according to an input command, and when this operation is completed, transmit a completion response to the UFS host 4100.

In an embodiment, when the UFS host 4100 intends to store user data in the UFS device 4200, the UFS host 4100 may transmit a data storage command to the UFS device 4200. When a response indicating that user data is ready to be transferred (ready-to-transfer) is received from the UFS device 4200, the UFS host 4100 may transfer the user data to the UFS device 4200. The UFS device controller 4210 may temporarily store the received user data in the device memory 4240, and may store the user data temporarily stored in the device memory 4240 in a selected position of the nonvolatile memory 4220 based on the address mapping information of the FTL.

In an embodiment, when the UFS host 4100 intends to read user data stored in the UFS device 4200, the UFS host 4100 may transmit a data read command to the UFS device 4200. The UFS device controller 4210 that receives a command may read user data from the non-volatile memory 4220 based on the data read command, and may temporarily store the read user data in the device memory 4240. During this read process, the UFS device controller 4210 may detect and correct an error in read user data using a built-in error correction code (ECC) engine (not shown). More specifically, the ECC engine may generate parity bits for write data to be written to the nonvolatile memory 4220, and the parity bits thus generated may be stored in the nonvolatile memory 4220 together with the write data. When reading data from the nonvolatile memory 4220, the ECC engine may correct an error in the read data using parity bits read from the nonvolatile memory 4220 together with the read data, and may output the read data with the error corrected.

In an embodiment, the UFS device controller 4210 may include the command generation module 1211 of FIG. 1. In an embodiment, the UFS device controller 4210 may generate a select chip pause command that pauses data output of one plane among multiple planes of the nonvolatile memory device 4220 and instructs data output of another plane. In an embodiment, the select chip pause command may include header data for pausing data output, select chip enable data for instructing data output, and a plane index for selecting a plane to output data.

In an embodiment, the UFS host 4100 may sequentially store commands to be transmitted to the UFS device 4200 in the UFS host register 4111 that may function as a command queue, and may transmit the commands to the UFS device 4200 in the sequential order. In this case, the UFS host 4100 may transmit a next command that is on standby in the command queue to the UFS device 4200 even when the previously transmitted command is still being processed by the UFS device 4200, that is, even before receiving a notification that the previously transmitted command has been completed by the UFS device 4200, and accordingly, the UFS device 4200 may also receive the next command from the UFS host 4100 even while processing the previously transmitted command. In addition, the command queue may be implemented as a circular queue type, where a head pointer and a tail pointer respectively represent a start and an end of a sequence of commands stored in the queue.

In an embodiment, VCC, VCCQ, VCCQ2, etc. may be input as power voltages to the UFS device 4200. The VCC may be a main power voltage for the UFS device 4200, which may have a value between 2.4 and 3.6 V. The VCCQ may be a power supply voltage for providing a low range of voltage, and primarily intended for the UFS device controller 4210, which may have a value between 1.14 and 1.26V. The VCCQ2 may be a power supply voltage for providing a range of voltage that is lower than the VCC but higher than the VCCQ, and primarily intended for input/output interfaces such as the MIPI M-PHY 4251, which may have a value between 1.7 and 1.95V. Power supply voltages may be supplied to each component of the UFS device 4200 via the regulator 4260. The regulator 4260 may be implemented as a set of unit regulators each connected to a different one of the aforementioned power supply voltages.

While this disclosure contains many specific embodiment details, these should not be construed as limitations on the scope of what may be claimed. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A storage device comprising:
a nonvolatile memory device including a plurality of planes and a plurality of page buffers respectively connected to the plurality of planes; and
a storage controller configured to
provide, to the nonvolatile memory device, a read command for reading data stored in the plurality of planes,
provide, to the nonvolatile memory device, a first select chip pause command for instructing data output of a first plane of the plurality of planes, and
provide, to the nonvolatile memory device, a second select chip pause command for pausing the data output of the first plane and instructing data output of a second plane of the plurality of planes.

2. The storage device of claim 1, wherein the second select chip pause command includes:
header data for pausing data output;
second select chip enable data for instructing data output; and
a second plane index for selecting the second plane to output data.

3. The storage device of claim 2, wherein the nonvolatile memory device is configured to:
pause the data output of the first plane based on the header data;
select the second plane based on the second plane index; and
output, to the storage controller and based on the second select chip enable data, second data stored in a second page buffer of the plurality of page buffers that is connected to the second plane.

4. The storage device of claim 2, wherein
the second select chip pause command includes a logical unit number that selects the nonvolatile memory device.

5. The storage device of claim 1, wherein
the first select chip pause command includes first select chip enable data for instructing data output and a first plane index for selecting the first plane to output data.

6. The storage device of claim 5, wherein
the nonvolatile memory device is configured to:
select the first plane based on the first plane index; and
output, to the storage controller and based on the first select chip enable data, first data stored in a first page buffer of the plurality of page buffers that is connected to the first plane.

7. The storage device of claim 1, wherein
the storage controller is configured to:
provide, to the nonvolatile memory device, a third select chip pause command for pausing the data output of the second plane and instructing data output of a third plane of the plurality of planes; and
provide, to the nonvolatile memory device, a select chip terminate command for terminating data output of the nonvolatile memory device.

8. The storage device of claim 1, wherein
the storage controller is configured to provide the second select chip pause command to the nonvolatile memory device via a command/address line based on receiving data of the first plane from the nonvolatile memory device via a data line.

9. The storage device of claim 1, wherein
the storage controller is configured to provide a fourth select chip pause command to the nonvolatile memory device, the fourth select chip pause command including header data for pausing data output and select chip terminate data for terminating data output of the nonvolatile memory device.

10. The storage device of claim 1, wherein
the nonvolatile memory device is configured to store, in the page buffers, data that are stored in the planes in response to the read command.

11. A memory device comprising:
a memory cell array including a plurality of planes;
a plurality of page buffers respectively connected to the plurality of planes; and
a control logic circuit configured to
sense, in the plurality of page buffers, data that are stored in the plurality of planes in response to a read command received from a first device, and
control the plurality of page buffers to output, to the first device, first data stored in a first page buffer, the first page buffer being connected to a first plane of the plurality of planes, and
in response to a first select chip pause command received from the first device,
pause output of the first data, and
output, to the first device, second data stored in a second page buffer, the second page buffer being connected to a second plane of the plurality of planes.

12. The memory device of claim 11, wherein
the first select chip pause command includes header data for pausing data output, a plane index for selecting a plane of the plurality of planes to output data, and select chip enable data for instructing data output.

13. The memory device of claim 12, wherein
the control logic circuit is configured to:
control the first page buffer to pause the output of the first data based on the header data;
select the second plane based on the plane index; and
output the second data to the first device based on the select chip enable data.

14. The memory device of claim 11, wherein
the control logic circuit is configured to control the page buffers to output, to the first device, the first data in response to a select chip enable command received before the first select chip pause command.

15. The memory device of claim 11, wherein
the control logic circuit is configured to, in response to a second select chip pause command received after the first select chip pause command, control the page buffers to pause the output of the second data and output, to the first device, third data stored in a third page buffer of the plurality of page buffers, the third page buffer being connected to a third plane of the plurality of planes.

16. The memory device of claim 11, wherein
the control logic circuit is configured to control the page buffers to terminate output of data stored in the page buffers in response to a third select chip pause command, the third select chip pause command including header data for pausing data output and select chip terminate data.

17. The memory device of claim 11, wherein
the control logic circuit is configured to receive the first select chip pause command via a command/address line, and
the page buffers are configured to output the first data or the second data to the first device via a data line.

18. An operating method for a storage controller, comprising:
outputting a read command for reading data stored in a plurality of planes of a nonvolatile memory device;
outputting a first select chip pause command that instructs data output of a first plane of the plurality of planes; and
outputting a second select chip pause command that pauses the data output of the first plane and instructs data output of a second plane of the plurality of planes.

19. The operating method of claim 18, wherein
outputting the second select chip pause command includes outputting the second select chip pause command via a command/address line based on receiving data of the first plane via a data line.

20. The operating method of claim 18, comprising:
after outputting the second select chip pause command, outputting a third select chip pause command that pauses the data output of the second plane and instructs data output of a third plane of the plurality of planes; and
outputting a select chip terminate command that terminates data output of the nonvolatile memory device.
